(19) United States
(12) Patent Application Publication
(10) Pub. No.: US 2026/0067209 A1
(43) Pub. Date: Mar. 5, 2026

(54) METHOD FOR ENABLING MAC ROUTE IMPORTING BY ALL-ACTIVE MULTIHOMING LEAF SITE-ONLY DEVICES IN AN EVPN E-TREE SERVICE

(71) Applicant: CIENA CORPORATION, Hanover, MD (US)

(72) Inventors: Amal Karboubi, Oshawa (CA); Sami Boutros, Union City, CA (US)

(73) Assignee: CIENA CORPORATION, Hanover, MD (US)

(21) Appl. No.: 18/824,426

(22) Filed: Sep. 4, 2024

(51) Int. Cl. H04L 45/74

(52) U.S. Cl. CPC H04L 45/74

(57) ABSTRACT

Aspects of the subject disclosure may include, for example, identifying, by an apparatus, a media access control (MAC) address of a customer edge (CE) device, and advertising the MAC address in a MAC route based on the identifying, wherein the MAC route is tagged with an extended community that identifies an Ethernet Segment (ES) associated with the apparatus, the extended community enabling another apparatus that is also associated with the ES to import the MAC route. Other embodiments are disclosed.

### FIELD OF THE DISCLOSURE

The subject disclosure relates to enabling media access control (MAC) route importing by all-active multihoming Leaf site-only devices in a virtual private network (VPN), such as an Ethernet VPN (EVPN), that supports Ethernet Tree (E-Tree) services.

### BACKGROUND

As defined in Metro Ethernet Forum (MEF) 6.2, Ethernet Virtual Connection (EVC) Ethernet Services Definitions Phase 3, August 2014 (which is incorporated by reference herein in its entirety), E-Tree is a type of Ethernet service that is based upon a rooted-multipoint EVC. In an E-Tree service type, one or more Root user network interfaces (UNIs) may exchange data service frames with multiple Leaf UNIs, but each Leaf UNI can exchange data only with the Root UNI(s). Thus, a service frame sent from one Leaf UNI with a destination address of another Leaf UNI would not be delivered.

Solutions for supporting E-Tree in EVPNs and Virtual Private Local Area Network (LAN) Services (VPLS) have been specified in Request for Comments (RFC) 8317 (E-Tree Support in EVPN and Provider Backbone Bridging EVPN (PBB-EVPN), January 2018) and RFC 7796 (E-Tree Support in VPLS, March 2016), respectively, each of which is incorporated by reference herein in its entirety. RFC 8137, in particular, categorizes E-Tree into three scenarios 1, 2, and 3, depending on the nature of the Root/Leaf site association. A site is a physical location or branch office of a customer that includes one or more Attachment Circuits (ACs) connected to the EVPN. FIG. 1A illustrates an EVPN-based environment that supports E-Tree scenario 1. A network 105 interconnects Provider Edge (PE) devices 110, 120, and 130. The PE devices 110, 120, and 130 maintain respective EVPN Instances (EVI) 110v, 120v, and 130v that together form a unified instance of an EVPN. The PE devices 110, 120, and 130 are thus considered as belonging to the same EVPN. The network 105 can utilize multiprotocol label switching (MPLS) or any other underlying data plane, such as Segment Routing IPV6 (SRV6), for transport. Each of the EVIs 110v, 120v, and 130v is associated with one or more forwarding domains (FDs), also known as broadcast domains, that are managed via MAC-Virtual Routing and Forwarding (VRF)/bridge tables on the corresponding respective PE devices. Collectively, the EVIs 110v, 120v, and 130v extend these FDs over the broader EVPN. The PE device 110 is coupled to Customer Edge (CE) devices 112, 114 via respective ACs 112r, 114r associated with the EVI 110v. The PE device 120 is coupled to a CE device 122 via an AC 122f and to one or more other CE devices via respective ACs 125f associated with the EVI 120v. The PE device 130 is coupled to CE devices 132, 134 via respective ACs 132f, 134f associated with the EVI 130v. In E-Tree scenario 1, a given EVI on a PE device can either be associated with Root ACs or Leaf ACs, but not both. Of course, a PE device can have both Root ACs and Leaf ACs if the Root ACs are associated with one EVI and the Leaf ACs are associated with a different EVI. As illustrated in FIG. 1A, the ACs 112r, 114r associated with the EVI 110v on the PE device 110 are Root ACs, the ACs 122f, 125f associated with the EVI 120v on the PE device 120 are Leaf ACs, and the ACs 132f, 134f associated with the EVI 130v on the PE device 130 are also Leaf ACs.

Border Gateway Protocol (BGP) is a protocol that facilitates the exchange of routing and reachability information among autonomous systems (ASs). RFC 7432 (BGP MPLS-Based EVPN, February 2015), which is incorporated by reference herein in its entirety, describes procedures for a BGP MPLS-based EVPN solution, where PE devices learn MAC addresses from their attached CE devices and advertise these MAC addresses (along with MPLS label(s)) to other PE devices in the control plane using Multiprotocol BGP (MP-BGP), which allows for load balancing of traffic to/from CE devices that are multihomed to multiple PE devices. RFC 7432 defines BGP Network Layer Reachability Information (NLRI) (also known as EVPN NLRI), and specifies four Route Types, namely Route Type 1 for Ethernet Auto-Discovery (A-D) route, Route Type 2 for MAC/Internet Protocol (IP) advertisement route, Route Type 3 for inclusive Multicast Ethernet Tag route, and Route Type 4 for Ethernet Segment route. RFC 7432 essentially uses the definition of Route Type 2 to extend BGP so as to allow PE devices to advertise MAC addresses, whether they are learned via local learning in the local data plane or via remote learning in the control plane.

As specified in RFC 8317, E-Tree scenario 1 utilizes tailored BGP route target import/export policies to prevent PE devices that belong to the same EVI, but that are associated with Leaf ACs on that EVI, from communicating with one another. Such PE devices are thus prevented from importing and processing BGP MAC routes from each other. To implement this topology constraint in EVPN, RFC 8317 defines two BGP Route Targets for each EVI:
an Export Root Route Target (or simply, Root Route Target) associated with Root sites (or ACs); and
an Export Leaf Route Target (or simply, Leaf Route Target) associated with Leaf sites (or ACs).
The BGP Route Target export policy requires that, for a given EVI, PE devices export the particular BGP Route Target that is associated with its type of sites or ACs. The BGP Route Target import policy allows, for a given EVI, a PE device that is associated with Root sites or ACs to be able to import both Root Route Targets and Leaf Route Targets, and allows, for a given EVI, a PE device that is associated with Leaf sites or ACs to be able to import only Root Route Targets (and not Leaf Route Targets). Further, to prevent communications between Leaf ACs that are connected to the same PE device, and belonging to the same EVI, split-horizon filtering (140 of FIG. 1A) is used to block traffic from one Leaf AC to another Leaf AC on a MAC-VRF/bridge table.

When implementing E-Tree scenario 1 as specified in RFC 8317, it is possible for a PE device that is attached to an all-active multihomed (MH) Ethernet Segment via a Leaf AC to undergo permanent traffic flooding. FIG. 1B illustrates an EVPN-based environment in which undesired permanent traffic flooding may occur at a PE device. The CE device 132 in FIG. 1B is multihomed, in an all-active mode, to both of the PE devices 120 and 130, thereby forming an Ethernet Segment (assume that its Ethernet Segment Identifier (ESI) is ESI1). Although not illustrated in FIG. 1B, assume that the PE devices 120 and 130 have each already learned that it is part of the Ethernet Segment (e.g., based on administrator-provided configurations in the PE devices 120 and 130 and/or the exchange of Route Type 4). Also, assume that, at the outset, neither of the PE devices 120 and 130 has learned the MAC address—i.e., MAC A—of the CE device 132. At 150, only the PE device 120 learns MAC A—e.g., say, in the local data plane based on load balanced traffic received from the CE device 132. By virtue of the all-active mode multihoming, the CE device 132 “views” the PE devices 120 and 130 as a single virtual entity of the Ethernet Segment. As a result, the CE device 132 might, for instance, perform load balancing and decide to hash traffic only to the PE device 120, in which case only the PE device 120 receives the traffic and learns MAC A, whereas the PE device 130 does not. At 152, the PE device 120 may, in accordance with the BGP Route Target export policy, advertise MAC A using an EVPN Route Type 2 MAC route that is tagged with a Leaf Route Target (per the Route Type 2 definition, the ESI value (e.g., ESI1) will also be specified in the MAC route). Being associated with only Root ACs, the PE device 110 may, at 154 and in accordance with the BGP Route Target import policy, import MAC A due to the Leaf Route Target. In contrast, being associated with only Leaf ACs, the PE device 130 may, in accordance with the BGP Route Target import policy, not import MAC A due to the absence of a Root Route Target. Since ESI1 is for an all-active mode Ethernet Segment, if a unicast frame is sent (at 156) from, say, the CE device 112 with MAC A as the destination address, the PE device 110 may (at 158) perform aliasing/load balancing to load balance the traffic to all members of the Ethernet Segment—i.e., the PE devices 120 and 130—despite the fact that MAC A was only learned from the PE device 120. Because the PE device 130 does not import the MAC A due to the absence of a Root Route Target, when the PE device 130 receives the traffic with destination MAC A, the PE device 130 will treat the traffic as unknown and constantly flood the traffic to all of the local AC ports that are associated with the Layer 2 (L2) FD. This behavior can cause undue network congestion, wasted bandwidth, queuing, etc., and thus negatively impact overall network performance.

### BRIEF DESCRIPTION OF THE DRAWINGS

Reference will now be made to the accompanying drawings, which are not necessarily drawn to scale, and wherein:

FIG. 1A illustrates an EVPN-based environment that supports E-Tree scenario 1.

FIG. 1B illustrates an EVPN-based environment in which undesired permanent traffic flooding may occur at a PE device.

FIG. 2A illustrates another EVPN-based environment in which the undesired permanent flooding of traffic of FIG. 1B is prevented, in accordance with various aspects described herein.

FIG. 2B is a diagram of an example environment in which the system of FIG. 2A may function or be operatively overlaid upon, in accordance with various aspects described herein.

FIG. 2C is a diagram of example components of a device that corresponds to one or more devices of the system of FIG. 2A, in accordance with various aspects described herein.

FIG. 3A depicts an illustrative embodiment of a method in accordance with various aspects described herein.

FIG. 3B depicts an illustrative embodiment of another method in accordance with various aspects described herein.

FIG. 4 is a block diagram of an example, non-limiting embodiment of a computing environment in accordance with various aspects described herein.

### DETAILED DESCRIPTION

In the context of RFC 8137 E-Tree scenario 1 described above, it would be beneficial to enable a Leaf AC to import a route if the route is learned over another Leaf AC that is part of the same all-active multihomed Ethernet Segment and also the same EVPN service. The subject disclosure describes, among other things, illustrative embodiments of methods in the context of EVIs of an EVPN that supports E-Tree services, where an extended community, such as a Route Target extended community (e.g., an ES-Import Route Target) that identifies an Ethernet Segment, is leveraged to facilitate importing of a MAC route by PE devices that are associated with Leaf ACs that are locally attached to the same Ethernet Segment. In one or more embodiments, PE devices that are associated with Leaf ACs may advertise an EVPN Route Type 2 MAC route that is formatted to include not only a Leaf Route Target, but also an extended community, such as a Route Target extended community (e.g., an Ethernet Segment (ES)-Import Route Target) that identifies an Ethernet Segment. These PE devices may also process a received EVPN Route Type 2 MAC route advertisement that is in such a format, and, for any given Leaf AC of the PE device, import the MAC route despite the absence of a Root Route Target, if two conditions are satisfied: (i) the value included in the ES-related extended community corresponds to an Ethernet Segment that the PE device (or that Leaf AC) itself is also a member of (e.g., the ES-Import Route Target in the MAC route matches a local ES-Import Route Target associated with that Leaf AC) and (ii) the Leaf Route Target in the MAC route matches a local Export Leaf Route Target used by that Leaf AC.

Various aspects of the methods described herein and/or similar techniques may be incorporated, as an exception and/or extension/addendum, in one or more standards—e.g., RFC 8317, RFC 7432, RFC 7796, and/or one or more other BGP-, EVPN-, VPLS-, and/or E-Tree-related standards associated with the Internet Engineering Task Force (IETF)—to support proper connectivity for all-active multihoming. For instance, various aspects of the method may be defined in an exception to the BGP Route Target import/export policies specified in RFC 8317 and/or in an extension to the usage of the ES-Import Route Target specified in RFC 7432. Defining an exception to the BGP Route Target import/export policies, for instance, advantageously relaxes the topological constraint(s) of E-Tree scenario 1 in RFC 8317, particularly in situations where PE devices that are associated with only Leaf ACs are members of the same Ethernet Segment. Allowing such PE devices to learn MAC route(s) from one another, despite the Leaf Route Target constraint, reduces or eliminates the possibility of these PE devices being subjected to the above-described traffic flooding condition when known unicast traffic is sent to those MAC(s) via aliasing/load balancing. The benefit of aliasing and load balancing of traffic can thus be maintained for Leaf AC-only PE devices that are part of an all-active MH group attached to the same CE device or Ethernet segment. Further, since Leaf Route Targets for Leaf ACs that are associated with the same EVPN E-Tree service will generally match each other, condition (ii) described above can also prevent Leaf ACs that are associated with different EVPN services, even if they are hosted on the same Ethernet Segment (i.e., same ESI), from importing each other's MAC routes. This advantageously ensures independent management of policies, settings, etc. per service and thus service-based separation.

One or more aspects of the subject disclosure include an apparatus, comprising one or more processors, and a memory that stores executable instructions that, when executed, cause the one or more processors to perform operations that include identifying a media access control (MAC) address of a customer edge (CE) device, and advertising the MAC address in a MAC route based on the identifying, wherein the MAC route is tagged with an extended community that identifies an Ethernet Segment (ES) associated with the apparatus, the extended community enabling another apparatus that is also associated with the ES to import the MAC route.

One or more aspects of the subject disclosure include a device, comprising one or more processors, and a memory that stores executable instructions that, when executed, cause the one or more processors to perform operations that include receiving a media access control (MAC) route from another device, wherein the MAC route is tagged with an extended community that identifies an Ethernet Segment (ES), and importing the MAC route based at least in part on a determination that the device is associated with the ES.

One or more aspects of the subject disclosure include a method, comprising at least one of outputting, by a processing system of a device including a processor, a media access control (MAC) route that is tagged with an extended community, wherein the extended community identifies an Ethernet Segment (ES) that is associated with the device, or responsive to receiving, by the processing system and from another device, another MAC route that is tagged with another extended community, importing the another MAC route based at least in part on a determination that the another extended community identifies the ES.

Other embodiments are described in the subject disclosure.

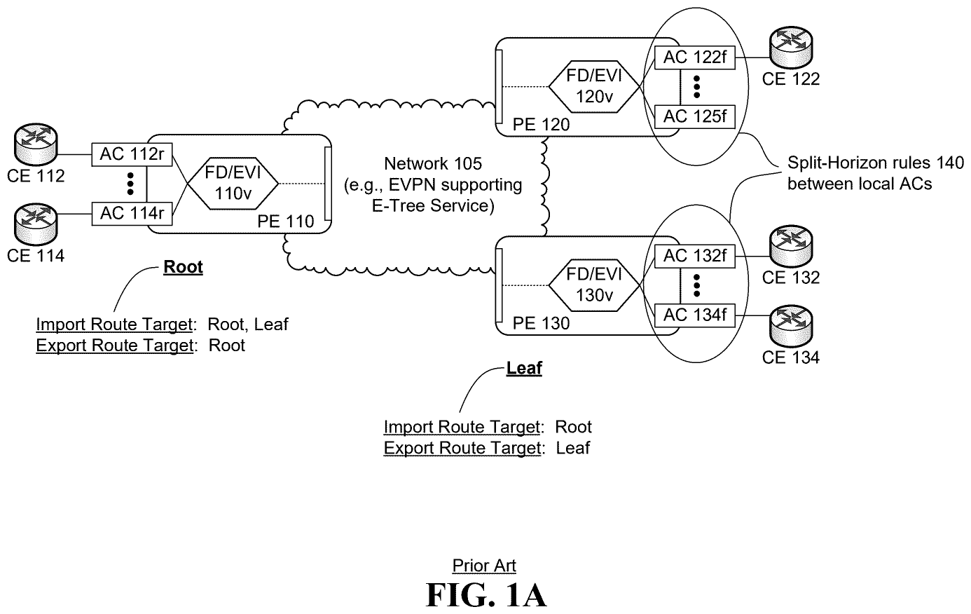

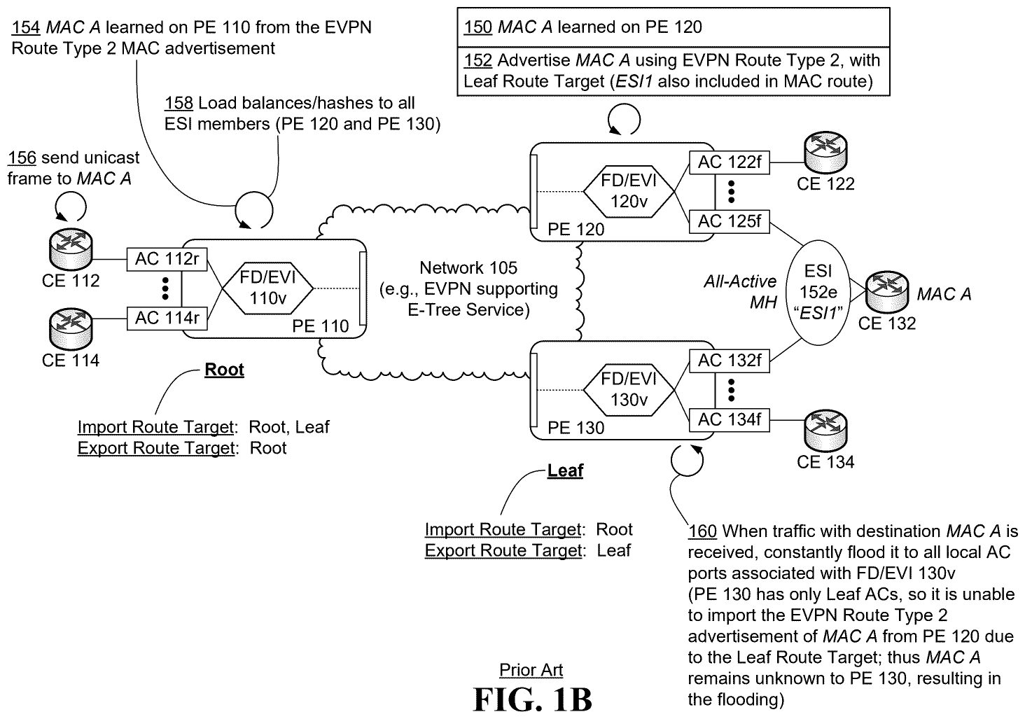

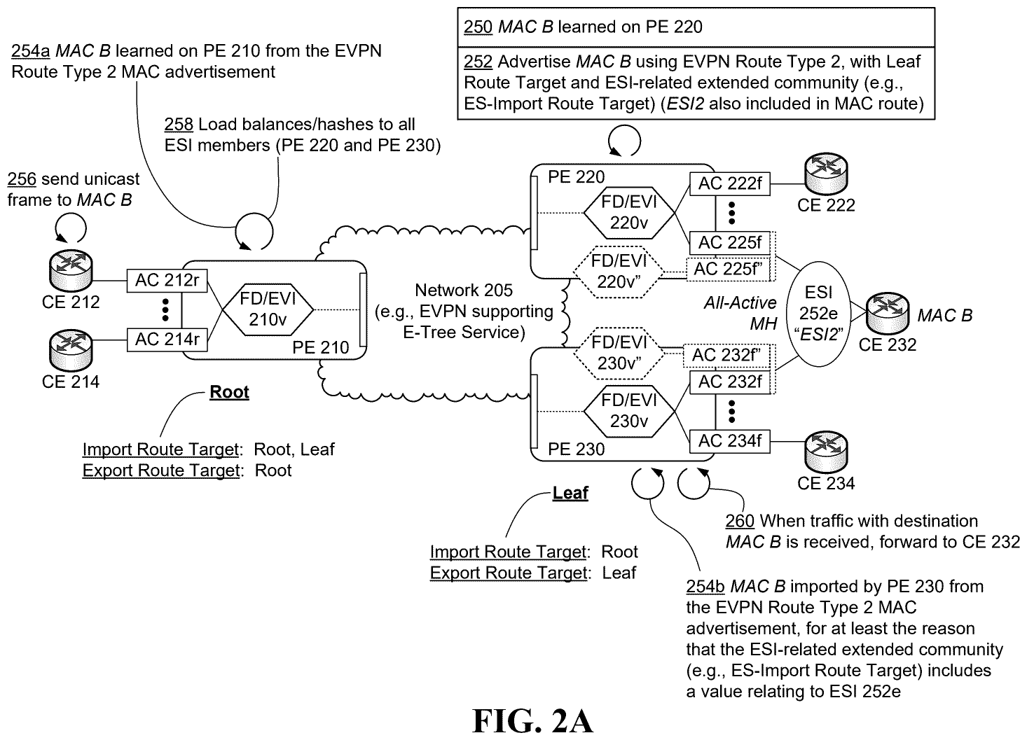

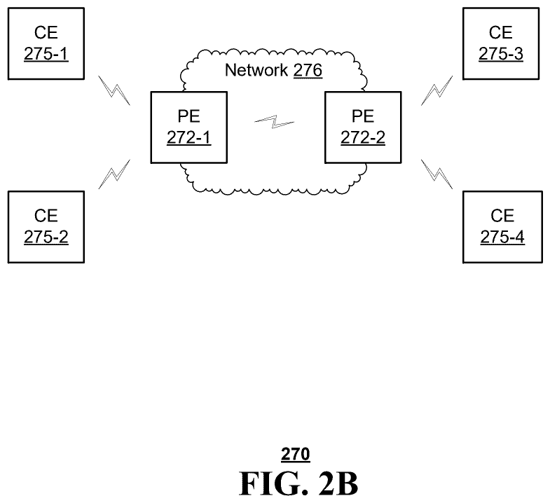

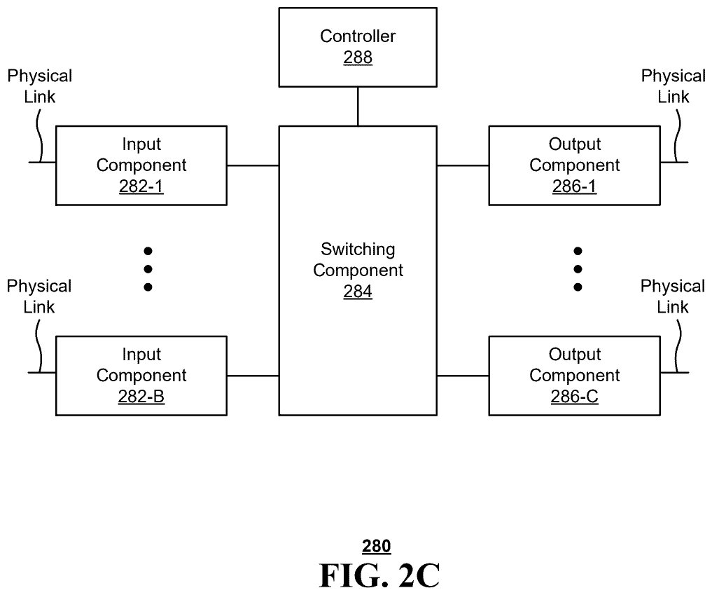

FIG. 2A illustrates another EVPN-based environment in which the undesired permanent flooding of traffic of FIG. 1B is prevented, in accordance with various aspects described herein. A network 205 may utilize MPLS for transport, and may interconnect PE devices 210, 220, and 230 that maintain respective EVIs 210v, 220v, and 230v. The PE device 210 may be coupled to CE devices 212, 214 via respective ACs 212r, 214r associated with the EVI 210v, the PE device 220 may be coupled to a CE device 222 via an AC 222f and to one or more other CE devices (such as CE device 232) via respective ACs 225f associated with the EVI 220v, and the PE device 230 may be coupled to CE devices 232, 234 via respective ACs 232f, 234f associated with the EVI 230v. The various components/devices of FIG. 2A may correspond to (or may be similar to) the various components/devices of FIGS. 1A and/or 1B, such as the network 105, the PE devices 110, 120, and 130, and the CE devices 112, 114, 122, 132, and 134, and thus the general descriptions of these components/devices and their associated features/connections will not be repeated for the sake of brevity. However, functionalities relating to associating an EVPN Route Type 2 MAC route advertisement with an ES-related extended community (e.g., an ES-Import Route Target) for (e.g., all) MACs learned from a PE device's Leaf AC that is part of an all-active MH Ethernet Segment are described below.

Similar to that described above with respect to FIG. 1B, the CE device 232 in FIG. 2A may be multihomed, in an all-active mode, to both of the PE devices 220 and 230, thereby forming an Ethernet Segment (assume that its ESI is ESI2). Although not illustrated in FIG. 2A, assume that the PE devices 220 and 230 have each already learned that it is part of the Ethernet Segment (e.g., based on administrator-provided configurations in the PE devices 220 and 230 and/or various Ethernet Segment-related route exchanges). Also assume that, at the outset, neither of the PE devices 220 and 230 has learned the MAC address—i.e., MAC B—of the CE device 232. At 250, only the PE device 220 learns MAC B—e.g., say, in the local data plane based on load balanced traffic received from the CE device 232. By virtue of the all-active mode multihoming, the CE device 232 “views” the PE devices 220 and 230 as a single virtual entity of the Ethernet Segment. As a result, the CE device 232 might, for instance, perform load balancing and decide to hash traffic only to the PE device 220, in which case only the PE device 220 receives the traffic and learns MAC B, whereas the PE device 230 does not. At 252, the PE device 220 may advertise MAC B using an EVPN Route Type 2 MAC route that is tagged with a Leaf Route Target as well as an ES-related extended community (i.e., the ES-Import Route Target). Per the Route Type 2 definition, the ESI value (e.g., ESI2) will also be specified in the MAC route. Being associated with only Root ACs, the PE device 210 may, at 254a and in accordance with the BGP Route Target import policy, import the MAC B due to the Leaf Route Target as per usual behavior defined in RFC 8137 and RFC 7432. At 254b, the PE device 230 may import the MAC B as a local MAC route based on the presence of the ES-Import Route Target corresponding to the all-active MH Ethernet Segment that the PE device 230 is locally attached to. In a case where the ES-Import Route Target is used, the PE device 230 may import the MAC B as a local MAC route in a L2 MAC-VRF/table (i.e., similar to how, per conventional EVPN-related processing, a PE device that receives an EVPN Route Type 2 MAC route with an ESI corresponding to a locally attached Ethernet Segment will import the MAC route as a local MAC route). Of course, one skilled in the art would readily recognize that, in many instances, multiple EVPN E-Tree services may be hosted on the same Ethernet Segment (i.e., same ESI). For instance, in FIG. 2A, the FD/EVI 220v (with a Leaf AC 225f) of the PE device 220 and the FD/EVI 230v (with Leaf AC 232f) of the PE device 230 may be associated with one EVPN E-Tree service hosted on the Ethernet Segment ESI2, whereas the dashed components—i.e., an FD/EVI 220v″ (with a Leaf AC 225f″) of the PE device 220 and an FD/EVI 230v″ (with a Leaf AC 232f″) of the PE device 230—may be associated with another EVPN E-Tree service on the Ethernet Segment ESI2. In this context of multiplexed EVPN E-Tree services on the same Ethernet Segment, it would be necessary to prevent Leaf ACs that are associated with different EVPN E-Trec services from importing each other's MAC routes so as to ensure service-based separation. Thus, in certain exemplary embodiments, an additional check may be made by the receiving PE device to ensure matching on Leaf Route Target from an export perspective. That is, in addition to requiring that the ES-import Route Target tagged to the MAC route match a local ES-Import Route Target, the Leaf Route Target tagged to the MAC route must also match a local service export Route Target (thus indicating the same local EVI) in order for the MAC route to be imported. Since, the Leaf ACs associated with a given EVPN E-Tree service generally use the same Leaf Route Target (an example one could be RT: 65000:1001), the additional check can prevent other Leaf ACs associated with another EVPN service (and that use a different Leaf Route Target—e.g., RT: 65000:1002) from importing routes advertised by those Leaf ACs, and vice versa, even if the services are hosted on the same Ethernet Segment (i.e., same ESI). To further illustrate, if, at step 250 of FIG. 2A, the PE device 220 learns a MAC address over the Leaf AC 225f and advertises it using an EVPN Route Type 2 MAC route that is tagged with a Leaf Route Target and an ES-Import Route Target, then, at step 254b, the PE device 230 would be prevented from importing the MAC route for the Leaf AC 232f″ due to the Leaf AC 225f and the Leaf AC 232f″ being associated with different EVPN E-Tree services, but the PE device 230 would be able to import the MAC route for the Leaf AC 232f due to the Leaf AC 225f and the Leaf AC 232f being associated with the same EVPN E-Tree service. Likewise, if, at step 250, the PE device 220 learns a MAC address over the Leaf AC 225f″ and advertises it using an EVPN Route Type 2 MAC route that is tagged with a Leaf Route Target and an ES-Import Route Target, then, at step 254b, the PE device 230 would be prevented from importing the MAC route for the Leaf AC 232f due to the Leaf AC 225f″ and the Leaf AC 232f being associated with different EVPN E-Tree services, but the PE device 230 would be able to import the MAC route for the Leaf AC 232f″ due to the Leaf AC 225f″ and the Leaf AC 232f″ being associated with the same EVPN E-Tree service.

In various embodiments, the PE device 230 may perform BGP processing of the received Route Type 2 MAC route to determine (sequentially or in a parallel manner) whether the MAC route advertisement is tagged with any community to which the PE device 230 belongs. As an example, the PE device 230 may, for a given Leaf AC of the PE device 230 and based upon receiving the Route Type 2 MAC route, first determine that there is no L2 MAC-VRF/table “listening” for a Leaf Route Target, may subsequently determine that, for that Leaf AC, there is an L2 MAC-VRF/table listening for an ES-related extended community (such as the ES-Import Route Target), and may import the MAC route for that Leaf AC based on this subsequent determination if the ES-related value therein corresponds to an Ethernet Segment that the PE device 230 (or that Leaf AC) is a member of (e.g., ES-Import Route Targets match) and if the MAC route is tagged with a Leaf Route Target that matches a local service export Route Target associated with that Leaf AC (e.g., export Leaf Route Targets match). Alternatively, the PE device 230 may, upon receiving the Route Type 2 MAC route, determine (e.g., immediately) that there is an L2 MAC-VRF/table listening for an ES-related extended community (such as the ES-Import Route Target), and may (e.g., immediately) import the MAC route based on this determination if the ES-related value therein corresponds to the Ethernet Segment that the PE device 230 (or that Leaf AC) is a member of (e.g., ES-Import Route Targets match) and if the MAC route is tagged with a Leaf Route Target that matches the local service export Route Target (e.g., export Leaf Route Targets match). In any case, at 256 of FIG. 2A, the CE device 212 may send a unicast frame with MAC B as the destination address. At 258, the PE device 210 may perform aliasing/load balancing to load balance the traffic to all members of the Ethernet Segment—i.e., the PE devices 220 and 230. Because the PE device 230 has already learned MAC B as described above, when the PE device 230 receives the traffic with destination MAC B, the PE device 230 may, at 260, properly forward that traffic to the CE device 232.

Those skilled in the art would understand and appreciate that an ES-import Route Target, as described herein, constitutes information that is in addition to the main or default Route Targets of an EVPN Route Type 2 MAC route, and that such an ES-Import Route Target is intended to enable a PE device in receipt of the EVPN Route Type 2 MAC route to behave in a particular manner. Particularly, tagging of an ES-Import Route Target to an EVPN Route Type 2 MAC route is intended to enable a PE device that is in receipt of the EVPN Route Type 2 MAC route to import the MAC route if the ES-Import Route Target identifies an ES that the PE device is a member of (e.g., subject to the above-described condition that the MAC route also be tagged with a Leaf Route Target that matches a local service export Route Target). It is believed that tagging a MAC route with an ES-Import Route Target is not presently implemented in any PE devices.

It is to be understood and appreciated that, although FIG. 2A might be described above as pertaining to various processes and/or actions that are performed in a particular order, some of these processes and/or actions may occur in different orders and/or concurrently with other processes and/or actions from what is depicted and described above. Moreover, not all of these processes and/or actions may be required to implement the systems and/or methods described herein. Furthermore, while various devices, network elements, etc. may have been illustrated in FIG. 2A as separate devices, network elements, etc., it will be appreciated that multiple devices, network elements, etc. can be implemented as a single device, network element, etc., or a single device, network element, etc. can be implemented as multiple devices, network elements, etc. Additionally, functions described as being performed by one device, network element, etc. may be performed by multiple devices, network elements, etc., or functions described as being performed by multiple devices, network elements, etc. may be performed by a single device, network element, etc.

FIG. 2B is a diagram of an example environment in which the system of FIG. 2A may function or be operatively overlaid upon, in accordance with various aspects described herein. Environment 270 may include CE devices 275-1 through 275-4 (collectively referred herein to as CE devices 275, and individually as CE device 275), PE devices 272-1 and 272-2 (collectively referred to herein as PE devices 272, and individually as PE device 272), and a network 276. The devices in environment 272 may be interconnected via wired connections, wireless connections, or a combination thereof.

The CE device 275 may include a device that is positioned at an edge of a customer network and that is capable of processing and/or transferring traffic associated with PE devices 272. For example, the CE device 275 may include a router, a switch, a hub, a bridge, a gateway, a modem, a server, a network interface card (NIC), an optical add-drop multiplexer (OADM), and/or the like. In various embodiments, a CE device 275 may be multihomed to multiple PE devices 272 (e.g., in an all-active mode), and may form ACs with such PE devices 272.

The PE device 272 may include a device that is positioned at an edge of a service provider network and that is capable of processing and/or transferring traffic associated with CE devices 275. For example, the PE device 272 may include a router, a switch, a hub, a bridge, a gateway, a modem, a server, a NIC, an OADM, and/or the like. In one or more embodiments, the PE device 272 may be an ingress PE device and/or an egress PE device that is associated with the network 276. In various embodiments, the PE device 272 may be a physical device that is implemented within a housing, such as a chassis. In certain embodiments, the PE device 272 may be a virtual device that is implemented by one or more computer devices of a data center or a cloud computing environment.

The network 276 may include one or more wired and/or wireless label switching networks that support EVPN, VPLS, and/or the like. For example, the network 276 may include an MPLS network, a generalized MPLS (GMPLS) network, and/or the like. In some embodiments, network 276 may include a LAN, a wide area network (WAN), a metropolitan area network (MAN), an ad hoc network, an intranet, an Internet, a private network, a fiber optic-based network, a cloud computing network, and/or a combination of some or all of these networks or other type(s) of networks.

The number and arrangement of devices and networks shown in FIG. 2B are provided as an example. In practice, there may be additional devices and/or networks, fewer devices and/or networks, different devices and/or networks, or differently arranged devices and/or networks than those shown in FIG. 2B. Furthermore, two or more devices shown in FIG. 2B may be implemented within a single device, or a single device shown in FIG. 2B may be implemented as multiple distributed devices. Additionally, or alternatively, a set of devices (e.g., one or more devices) of the environment 270 may perform one or more functions described as being performed by another set of devices of the environment 270.

FIG. 2C is a diagram of example components of a device 280 that corresponds to one or more devices of the system of FIG. 2A, in accordance with various aspects described herein. In some embodiments, one or more devices of FIGS. 2A and/or 2B may include one or more devices 280 and/or one or more components of the device 280. As shown in FIG. 2C, the device 280 may include one or more input components 282-1 through 282-B (B≥1) (hereinafter referred to collectively as “input components 282,” and individually as “input component 282”), a switching component 284, one or more output components 286-1 through 286-C (C≥1) (hereinafter referred to collectively as “output components 286,” and individually as “output component 286”), and a controller 288.

In various embodiments, the input component 282 may be points of attachment for physical links and may be points of entry for incoming traffic, such as packets. The input component 282 may process incoming traffic, such as by performing data link layer encapsulation or decapsulation. In some embodiments, the input component 282 may send and/or receive packets. In some embodiments, the input component 282 may include an input line card that includes one or more packet processing components (e.g., in the form of integrated circuits), such as one or more interface cards (IFCs), packet forwarding components, line card controller components, input ports, processors, memories, and/or input queues. In some embodiments, the device 280 may include one or more input components 282.

The switching component 284 may interconnect the input components 282 with the output components 286. In some embodiments, the switching component 284 may be implemented via one or more crossbars, via buses, and/or with shared memories. The shared memories may act as temporary buffers to store packets from the input components 282 before the packets are eventually scheduled for delivery to the output components 286. In some embodiments, the switching component 284 may enable the input components 282, the output components 286, and/or the controller 288 to communicate with one another.

The output component 286 may store packets and may schedule packets for transmission on output physical links. The output component 286 may support data link layer encapsulation or decapsulation and/or a variety of higher-level protocols. In some embodiments, the output component 286 may send packets and/or receive packets. In some embodiments, the output component 286 may include an output line card that includes one or more packet processing components (e.g., in the form of integrated circuits), such as one or more IFCs, packet forwarding components, line card controller components, output ports, processors, memories, and/or output queues. In some embodiments, the device 280 may include one or more output components 286. In some embodiments, input component 282 and output component 286 may be implemented by the same set of components (e.g., an input/output component may be a combination of input component 282 and output component 286).

The controller 288 may include a processor in the form of, for example, a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), and/or another type of processor that can interpret and/or execute instructions. A processor is implemented in hardware, firmware, or a combination of hardware and software. In some embodiments, the controller 288 may include one or more processors that can be programmed to perform a function.

In some embodiments, the controller 288 may include a random access memory (RAM), a read only memory (ROM), and/or another type of dynamic or static storage device (e.g., a flash memory, a magnetic memory, or an optical memory) that stores information and/or instructions for use by the controller 288.

In some embodiments, the controller 288 may communicate with other devices, networks, and/or systems connected to the device 280 to exchange information regarding network topology. The controller 288 may create routing tables based on the network topology information, create forwarding tables based on the routing tables, and forward the forwarding tables to the input components 282 and/or the output components 286. The input components 282 and/or the output components 286 may use the forwarding tables to perform route lookups for incoming and/or outgoing packets.

The controller 288 may perform one or more processes described herein. The controller 288 may perform these processes in response to executing software instructions stored by a non-transitory computer-readable medium. A memory device includes memory space within a single physical storage device or memory space spread across multiple physical storage devices.

Software instructions may be read into a memory and/or storage component associated with the controller 288 from another computer-readable medium or from another device via a communication interface. When executed, software instructions stored in a memory and/or storage component associated with the controller 288 may cause controller 288 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software.

The number and arrangement of components shown in FIG. 2C are provided as an example. In practice, the device 280 may include additional components, fewer components, different components, or differently arranged components than those shown in FIG. 2C. Additionally, or alternatively, a set of components (e.g., one or more components) of the device 280 may perform one or more functions described as being performed by another set of components of the device 280.

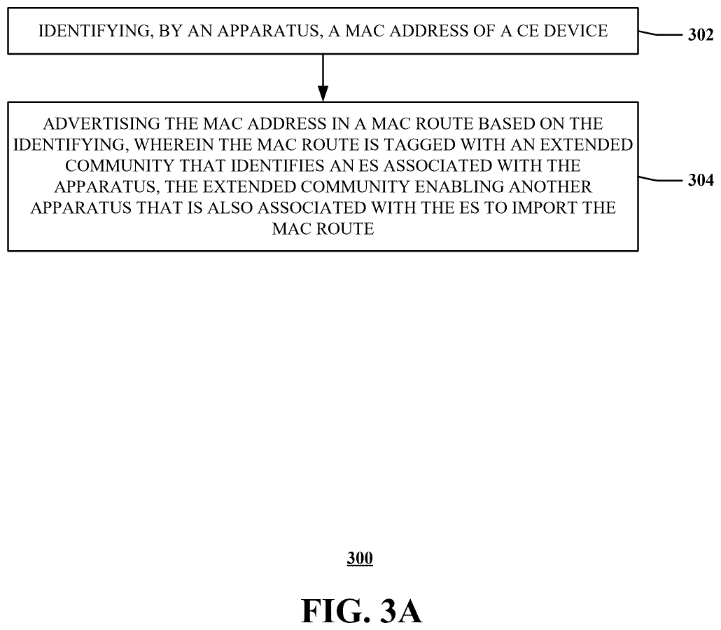

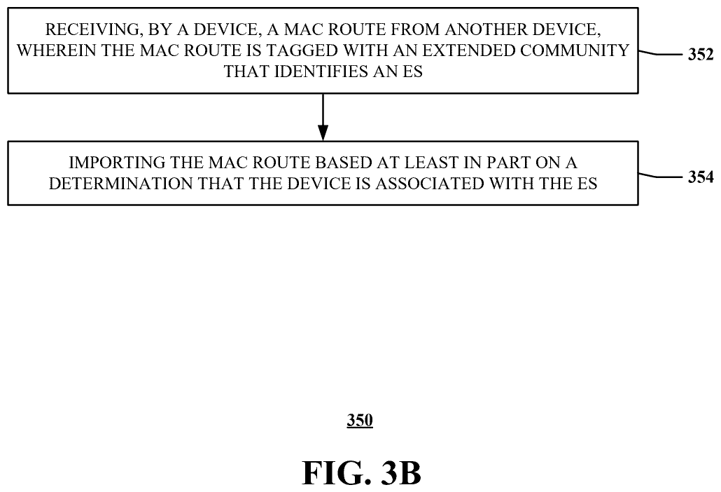

FIG. 3A depicts an illustrative embodiment of a method 300 in accordance with various aspects described herein.

At 302, the method can include identifying, by an apparatus, a MAC address of a CE device. For example, an apparatus, such as the PE device 220, can, similar to that described above with respect to FIG. 2A, perform one or more operations that include identifying MAC address MAC B of the CE device 232.

At 304, the method can include advertising the MAC address in a MAC route based on the identifying, wherein the MAC route is tagged with an extended community that identifies an ES associated with the apparatus, the extended community enabling another apparatus that is also associated with the ES to import the MAC route. For example, the PE device 220 can, similar to that described above with respect to FIG. 2A, perform one or more operations that include advertising the MAC address MAC B in a MAC route based on the identifying, wherein the MAC route is tagged with an extended community that identifies an Ethernet Segment (ESI2) associated with the PE device 220, the extended community enabling another apparatus, such as the PE device 230, that is also associated with the ES to import the MAC route.

While for purposes of simplicity of explanation, the respective processes are shown and described as a series of blocks in FIG. 3A, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

FIG. 3B depicts an illustrative embodiment of a method 350 in accordance with various aspects described herein.

At 352, the method can include receiving, by a device, a MAC route from another device, wherein the MAC route is tagged with an extended community that identifies an ES. For example, a PE device, such as the PE device 230, can, similar to that described above with respect to FIG. 2A, perform one or more operations that include receiving a MAC route from another device, such as the PE device 220, wherein the MAC route is tagged with an extended community that identifies an ES.

At 354, the method can include importing the MAC route based at least in part on a determination that the device is associated with the ES. For example, the PE device 230 can, similar to that described above with respect to FIG. 2A, perform one or more operations that include importing the MAC route based at least in part on a determination that the PE device 230 is associated with the ES. In certain exemplary embodiments, the importing may, similar to that described above with respect to FIG. 2A, additionally be based at least in part on another determination that the MAC route is tagged with a Leaf Route Target that matches a local export Leaf Route Target.

While for purposes of simplicity of explanation, the respective processes are shown and described as a series of blocks in FIG. 3B, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

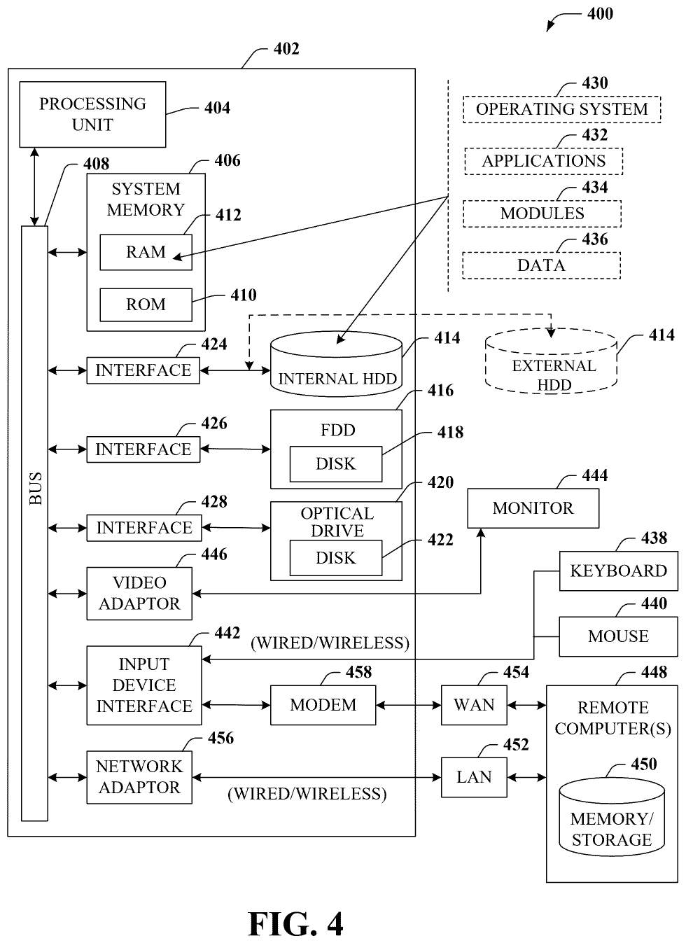

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, the computing environment 400 can be used in computing device described herein. Each of these devices can be implemented via computer-executable instructions that can run on one or more computers, and/or in combination with other program modules and/or as a combination of hardware and software. For example, computing environment 400 can facilitate, in whole or in part, enabling MAC route importing by all-active multihoming Leaf site-only devices in a VPN, such as an EVPN, that supports E-Tree services. Further, one or more of the devices/components/systems in FIG. 2A may include computing environment 400.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized. It is also to be understood and appreciated that the subject matter in one or more dependent claims may be combined with that in one or more other dependent claims.

What is claimed is:

1. An apparatus, comprising:
one or more processors; and
a memory that stores executable instructions that, when executed, cause the one or more processors to perform operations that include
identifying a media access control (MAC) address of a customer edge (CE) device, and
advertising the MAC address in a MAC route based on the identifying,
wherein the MAC route is tagged with an extended community that identifies an Ethernet Segment (ES) associated with the apparatus, the extended community enabling another apparatus that is also associated with the ES to import the MAC route.

2. The apparatus of claim 1, wherein the apparatus and the another apparatus are associated with an Ethernet Tree (E-Tree) implemented using an Ethernet Virtual Private Network (EVPN) that supports Request for Comments (RFC) 8137 E-Tree scenario 1 such that Root sites export Root Route Targets and import both Root Route Targets and Leaf Route Targets and such that Leaf sites export Leaf Route Targets and import Root Route Targets, and wherein the CE device is all-active multihomed (MH) to the apparatus and the another apparatus in the ES.

3. The apparatus of claim 1, wherein the MAC route is tagged with a Leaf Route Target, and wherein the extended community enables the another apparatus to import the MAC route despite an absence of a Root Route Target in the MAC route.

4. The apparatus of claim 1, wherein the identifying is based on data plane traffic received by the apparatus from the CE device over a Leaf attachment circuit (AC).

5. The apparatus of claim 1, wherein the MAC route comprises an Ethernet Virtual Private Network (EVPN) Route Type 2 MAC route.

6. The apparatus of claim 1, wherein the extended community comprises an ES-Import Route Target that includes a value relating to an Ethernet Segment Identifier (ESI) of the ES.

7. The apparatus of claim 1, wherein the extended community enables the another apparatus to import the MAC route in a Layer 2 (L2) table as a local MAC route.

8. The apparatus of claim 1, wherein the advertising is in accordance with Multiprotocol Border Gateway Protocol (MP-BGP).

9. The apparatus of claim 1, wherein the executable instructions, when executed, further cause the one or more processors to perform operations that include
receiving another MAC route from yet another apparatus, wherein the another MAC route is tagged with a Leaf Route Target and another extended community that identifies a particular ES,
determining whether the Leaf Route Target matches a local export Leaf Route Target and whether the particular ES matches the ES, and
importing the another MAC route based at least in part on a determination that the Leaf Route Target matches the local export Leaf Route Target and that the particular ES matches the ES.

10. The apparatus of claim 1, wherein the executable instructions, when executed, further cause the one or more processors to perform operations that include
receiving another MAC route from yet another apparatus, wherein the another MAC route is tagged with a Leaf Route Target and another extended community that identifies a particular ES,
determining whether the Leaf Route Target matches a local export Leaf Route Target and whether the particular ES matches the ES, and
refraining from importing the another MAC route based at least in part on a determination that either the Leaf Route Target does not match the local export Leaf Route Target or that the particular ES does not match the ES.

11. The apparatus of claim 1, wherein the apparatus comprises a provider edge (PE) device.

12. A device, comprising:
one or more processors; and
a memory that stores executable instructions that, when executed, cause the one or more processors to perform operations that include
receiving a media access control (MAC) route from another device, wherein the MAC route is tagged with an extended community that identifies an Ethernet Segment (ES), and
importing the MAC route based at least in part on a determination that the device is associated with the ES.

13. The device of claim 12, wherein the device and the another device are associated with an Ethernet Tree (E-Tree) implemented using an Ethernet Virtual Private Network (EVPN) that supports Request for Comments (RFC) 8137 E-Tree scenario 1 such that Root sites export Root Route Targets and import both Root Route Targets and Leaf Route Targets and such that Leaf sites export Leaf Route Targets and import Root Route Targets, and wherein the MAC route includes a MAC address of a CE equipment that is all-active multihomed (MH) to the device and the another device in the ES.

14. The device of claim 12, wherein the MAC route is tagged with a Leaf Route Target, and wherein the executable instructions, when executed, further cause the one or more processors to perform operations that include
determining whether the Leaf Route Target matches a local export Leaf Route Target, wherein the importing is further based at least in part on a determination that the Leaf Route Target matches the local export Leaf Route Target.

15. The device of claim 12, wherein the executable instructions, when executed, further cause the one or more processors to perform operations that include
receiving another MAC route from yet another device, wherein the another MAC route is tagged with a Leaf Route Target and also another extended community that identifies the ES,
determining whether the Leaf Route Target matches a local export Leaf Route Target, and
refraining from importing the another MAC route based at least in part on a determination that the Leaf Route Target does not match the local export Leaf Route Target.

16. The device of claim 12, wherein the MAC route comprises an Ethernet Virtual Private Network (EVPN) Route Type 2 MAC route, and wherein the extended community comprises an ES-Import Route Target that includes a value relating to an Ethernet Segment Identifier (ESI) of the ES.

17. A method, comprising at least one of:
outputting, by a processing system of a device including a processor, a media access control (MAC) route that is tagged with an extended community, wherein the extended community identifies an Ethernet Segment (ES) that is associated with the device; or
responsive to receiving, by the processing system and from another device, another MAC route that is tagged with another extended community, importing the another MAC route based at least in part on a determination that the another extended community identifies the ES.

18. The method of claim 17, wherein the device and the another device are associated with an Ethernet Tree (E-Tree) implemented using an Ethernet Virtual Private Network (EVPN) that supports Request for Comments (RFC) 8137 E-Tree scenario 1 such that Root sites export Root Route Targets and import both Root Route Targets and Leaf Route Targets and such that Leaf sites export Leaf Route Targets and import Root Route Targets, and wherein the MAC route or the another MAC route includes a MAC address of a customer edge (CE) equipment that is all-active multihomed (MH) to the device and the another device in the ES.

19. The method of claim 17, wherein the another MAC route is tagged with a Leaf Route Target, and wherein the importing is further based at least in part on another determination that the Leaf Route Target matches a local export Leaf Route Target.

20. The method of claim 17, wherein at least one of the extended community or the another extended community comprises an ES-Import Route Target.
